(19) United States
(12) Patent Application Publication
(10) Pub. No.: US 2007/0016684 A1
(43) Pub. Date: Jan. 18, 2007

(54) System and method for facilitating use of network features

(75) Inventors: Jeremy Stieglitz, Menlo Park, CA (US); Jeevan Patil, San Jose, CA (US); Pradeep Badri, San Jose, CA (US)

Correspondence Address: Trellis Intellectual Property Law Group, PC, 1900 EMBARCADERO ROAD, SUITE 109, PALO ALTO, CA, 94303, US

(73) Assignee: Cisco Technology, Inc., San Jose, CA (US)

(21) Appl. No.: 11/181,555

(22) Filed: Jul. 13, 2005

(51) Int. Cl. H04L 9/32; G06F 12/14; G06F 15/16; G06K 9/00; G06F 17/30

(52) U.S. Cl. 709/229; 726/4; 726/21

(57) ABSTRACT

A system for facilitating use of services in a network. In an illustrative embodiment, the system includes a first mechanism for enabling a user to connect to the network. A second mechanism authenticates the user and provides a signal in response thereto. A third mechanism selectively displays information pertaining to services of the network in response to the signal. In a more specific embodiment, the network is a Public Wireless Local Area Network (PWLAN), and the first mechanism includes one or more local access points. In this embodiment, the second mechanism further facilitates determining which of the services the user is permitted to access and provides permission information in response thereto. The permission information is incorporated in the signal. The third mechanism further employs the permission information to indicate to the user which of the services the user is authorized to use or access.

### BACKGROUND OF THE INVENTION

This invention is related in general to processing of digital information and more specifically to systems and methods for facilitating use of network services.

Networks may provide various services, such as network gaming, video conferencing, printing, file transferring, and file-server browsing services. Such networks often demand user-friendly mechanisms and accompanying user interfaces that facilitate using the services.

Systems for facilitating use of network services are becoming particularly important in Wireless Local Area Network (WLAN) applications as feature-rich publicly accessible WLANs proliferate. The proliferation of network-enabled mobile computing devices, such as Wi-Fi (Wireless Fidelity) enabled wireless phones and pocket computers, further increases the demand for efficient access to network services and features, such as network gaming, video conferencing, printing, file transferring, file-server browsing, movie watching, music listening, file collaborating, and so on.

Unfortunately, existing systems for facilitating use of network services are often limited to individual application-specific interfaces for each service, which must be manually accessed. Information about network resources is often not readily available or must be obtained through tedious searching. Each time a user wishes to access a particular service, the user must often be specifically authenticated for that particular service. Consequently, users wishing to access multiple services may be authenticated multiple times, which is undesirably time consuming.

### BRIEF DESCRIPTION OF THE DRAWINGS

FIG. 1 is a diagram illustrating a system for facilitating detection and use of network services according to a first embodiment of the present invention.

FIG. 2 is more detailed diagram illustrating a system for facilitating detection and use of network services according to a second embodiment of the present invention.

FIG. 3 is a flow diagram of a first method adapted for use with the systems of FIGS. 1-2.

FIG. 4 is a flow diagram of a second method adapted for use with the systems of FIGS. 1-2.

### DETAILED DESCRIPTION OF EMBODIMENTS OF THE INVENTION

A preferred embodiment of the present invention implements a system for improving network feature utilization. In a preferred embodiment, the system is adapted for use with a WLAN and includes a first mechanism for enabling a user to connect to the network. A second mechanism authenticates the user and provides a signal in response thereto. A third mechanism selectively displays information pertaining to services of the network in response to the signal. Hence, the system facilitates determining available network services and thereby facilitates use of those services. As discussed more fully below, the system may further facilitate authenticating users for a particular service or set of services. Furthermore, the system may provide an efficient mechanism by which a merchant may charge for usage or access rights to different services.

For clarity, various well-known components, such as power supplies, communications ports, hubs, modems, gateways, firewalls, network cards, and so on, have been omitted from the figures. However, those skilled in the art with access to the present teachings will know which components to implement and how to implement them to meet the needs of a given application.

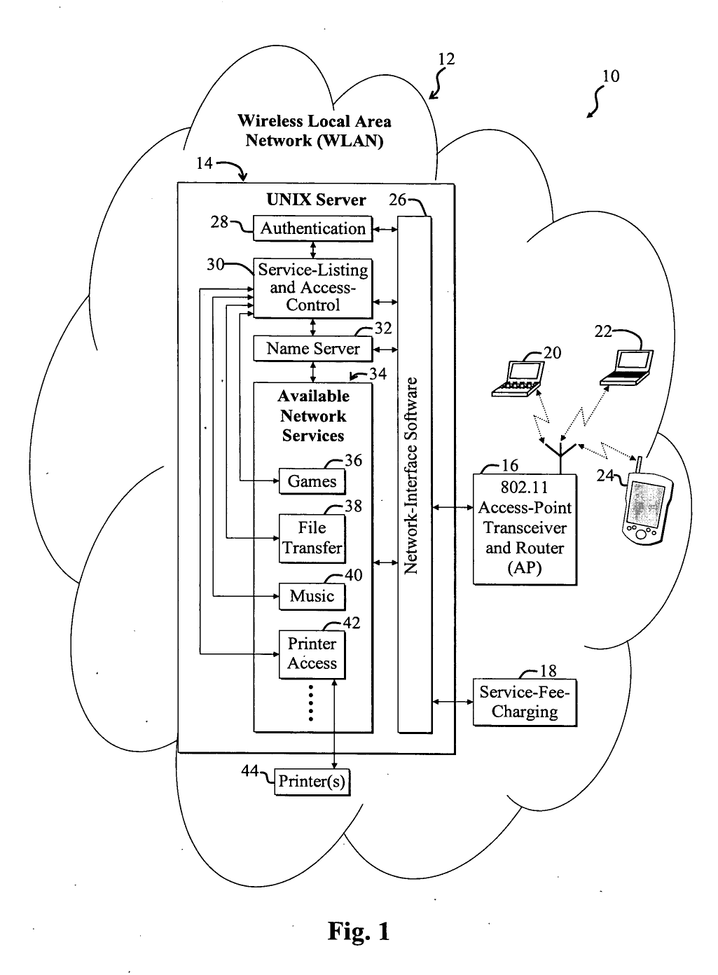

FIG. 1 is a diagram illustrating a system 10 for facilitating detection and use of network services according to a first embodiment of the present invention. In the present specific embodiment, the system 10 is implemented in a WLAN 12, which may be a Public WLAN (PWLAN), such as might be deployed in a library, coffee shop, school, and so on.

For the purposes of the present discussion, a service may be any available feature or function offered by a network. Examples of network services include accessible music files; network gaming applications, and so on. Generally, network users may employ network entities, such as client machines, to use or access the network services.

The WLAN 12 includes a primary Unix server 14, which communicates with a service-fee charging module 18 and a Wireless-Fidelity (Wi-Fi) access-point transceiver and router (AP) 16, which is constructed according to IEEE (Institute of Electrical and Electronics Engineers) 802.11 standards. The UNIX server 14 may communicate with plural clients, such as a first laptop computer 20, a second laptop computer 22, and a handheld computer 24, via the wireless access-point transceiver and router 16.

While the present embodiment employs a Wi-Fi AP 16 to facilitate connecting to the network 12, other types of network technologies may be employed without departing from the scope of the present invention. For example, Bluetooth, Worldwide Interoperability for Microwave Access (WiMAX), ultra-wideband, and other network technologies may be employed to facilitate network communications without departing from the scope of the present invention.

The UNIX server 14 includes network interface software 26, which facilitates interfacing the AP 16 to various server modules. Those skilled in the art will appreciate that the UNIX server 14 may be implemented via an operating system other than UNIX, such as Linux or Windows NT, without departing from the scope of the present invention.

The various server modules include an authentication module 28, a service-listing and access-control module 30, a name server module 32, and plural network services 34, which communicate with the network-interface software 26. For illustrative purposes, the plural network services 34 are shown implemented via a games module 36, a file-transfer module 38, a music module 40, and a printer-access module 42, which includes one or more printer drivers for facilitating printing operations via an attached printer 44.

The service-listing and access-control module 30 associates services with corresponding functionality. For example, printing and administering services are associated with printer functionality. The service-listing and access-control module 30 may interact with the printer software 42 and register users with the software 42 as users subscribe to various printer services. The name server 32 may facilitate mapping service names to addresses of hardware and/or software employed to provide the services.

The authentication module 28 further communicates with the service-listing and access-control module 30. The service-listing and access-control module 30 further communicates with the name server 32, and the various service modules 34-42. The name server 32, which may be implemented via a Domain Name Server (DNS) in certain applications, may communicate with available network services 34 as needed to register addresses, such as Internet Protocol (IP) addresses, of modules associated with newly added services. The name server 32 facilitates associating specific names of services, such as games, file transfers, printers, and so on, with numerical identifications of the services as needed.

For the purposes of the present discussion, the term available network services refers to all services that a network, such as the network 12, offers to a user or computer system, such as the client computer systems 20-24. Services to which a client 20-24 has subscribed are called subscribed services. The terms user and client are used interchangeably, since each client computer 20-24 is associated with and controlled by the user of each client computer 20-24.

The various network services 34 may be implemented via separate computers, distinct from the UNIX server 14, without departing from the scope of the present invention. Furthermore, the name server 32 may be omitted without departing from the scope of the present invention. In such implementations, if naming service is required, other remote name servers (not shown) may be employed to provide the necessary naming services. However, in certain implementations, the local name server 32 is particularly useful for facilitating associating certain terminology used to identify services in a list of services with the IP addresses of the devices associated with the services. For example, the term printer may be associated with the IP address of (or other number associated with) the printer 44 via the name server 32. The UNIX server 14 may communicate with an Internet Service Provider (ISP) to access the Internet, as discussed more fully below.

In operation, when users of the wireless-enabled client systems 20-24 come within range of the AP 16, they may detect and access the WLAN 12 via the AP 16. The range of the AP 16 defines a region called a hot spot. Upon detecting the presence of the WLAN 12, each client 20-24 employs client software, such as widely available networking software, to interact with the network-interface software 26.

In the present specific embodiment, the network-interface software 26 implements routines that facilitate associating each client system 20-24 and/or accompanying user with one or more parameters, i.e., that facilitate authenticating the clients 20-24 and/or accompanying users. The parameters may correspond to one or more user-access levels or categories. Examples of user-access levels include a bronze level, wherein users or clients associated with bronze permission or access rights may access the music files 40 only. A silver access-level may enable access to the music files 40 and collaborative applications, such as file transfers 38, network games 36, and so on. A gold access-level may enable access to all network services, including the games 36, file transfers 38, music 40, and access to the printer 44 via the printer-access module 42.

For the purposes of the present discussion, to authenticate means to associate with one or more parameters or to otherwise identify. In certain applications, authentication or identification is further facilitated or verified via passwords, biometrics, and so on.

Upon initially accessing the UNIX server 14, the service-listing and access-control module 30 facilitates communicating a list of the available network services 34-42 to the client systems 20-24. One or more parameters identify each user of each client system 20-24 and specify permission rights, also called access rights, which determine which of the network service modules 36-42 the client systems 20-24 are authorized to access and/or use. Names of services for which each client 20-24 is authorized to use or access may be displayed along with a list of all available network services 34-42 via the user interfaces of the client systems 20-24. For example, a user of the pocket-computer client 24 may have purchased rights to play the network games 36 but not any of the other services 38-42. In this example, the service-listing and access-control module 30 determines, based on access-permission parameters provided by the pocket computer 24, that the pocket computer 24 may only access the games 36. Consequently, the service-listing and access-control module 30 forwards a signal to the pocket computer 24 identifying available network services 34-42 and indicating that the pocket computer 24 will have access to the games 36 only. Information indicating available network services 34-42 and specifying which services are accessible based on the identification of the user and/or accompanying client 24 may be displayed via the display screen of the pocket computer 24 or may be communicated to the user of the client 24 via another mechanism. For example, available service information and permission information may be conveyed via audio signals without departing from the scope of the present invention.

When the service-listing and access-control module 30 determines which services a particular client 20-24 is authorized to access, appropriate control signals and accompanying parameters are then forwarded to service modules 34-42 to disable or enable access for a particular client 20-24. For example, if the pocket computer 24 has been authorized to access the games 36 only, then the file transfer module 38, the music module 40, and the printer access module 42 are disabled for the pocket computer 24 via control signals sent from the service-listing and access-control module 30. In this example, the control signals are associated with the pocket computer 24 and may incorporate corresponding identification information. Without departing from the scope of the present invention, various mechanisms other than the service-listing and access-control module 30 and accompanying control signals sent to/from the various service modules 34-42 may be employed to determine client-access rights and to selectively enable client-access rights to different network services.

In the present embodiment, the network-interface software 26 provides an option to each client 20-24 to subscribe to network services by purchasing different permission/access rights. Users of the client systems 20-24 may enter billing information, such as credit-card information, via the client systems 20-24, to purchase rights to use additional network services. The network-interface software 26 may facilitate displaying a billing Graphical User Interface (GUI) on the client devices 20-24, which lists available network services along with prices for each service. The network-interface software 26 may then forward the billing information to the service-fee-charging terminal 18 to charge for the purchased permission/access rights, i.e., service use rights. The service-fee-charging module 18 and the access point transceiver 16 and may be implemented via conventional components without departing from the scope of the present invention.

As new services become available, the new services may register with the name server 32 and/or the service-listing and access-control module 30. The service-listing and access-control module 30 then updates listings of available network services accordingly. Each client system 20-24 may receive an updated list of available network services from the service-listing and access-control module 30 when new network services are added.

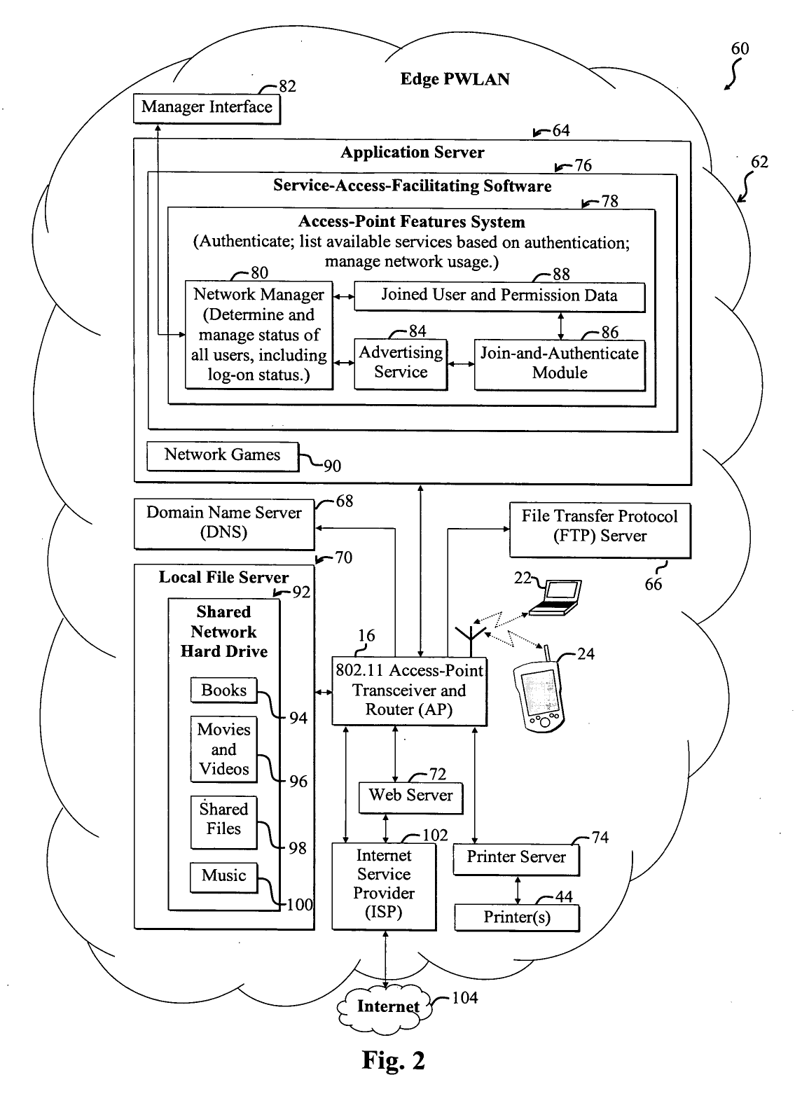

FIG. 2 is more detailed diagram of a system 60 for facilitating detection and use of network services according to a second illustrative embodiment of the present invention. The system 60 is associated with a network 62, which includes the wireless access-point transceiver and router (AP) 16. The AP 16 is shown communicating with the second laptop client 22 and the pocket-computer client 24. The AP 16 also communicates with various network servers, including an application server 64, a File Transfer Protocol (FTP) server 66, a DNS 68, a local file server 70, a web server 72, and a printer server 74. In the present embodiment, each of the servers 64-74 is associated with an IP address maintained by the DNS 68.

The application server 64 incorporates special service-access-facilitating software 76, which includes an access-point features system 78. The access-point features system 78 incorporates a network manager 80, which communicates with a manager interface 82. The manager interface 82 enables network service personnel or other authorized network users to configure and control the behavior of the network manager 80.

The access-point features system 78 further includes an advertising-service module 84, which communicates with both the network manager 80 and a join-and-authenticate module 86. The join-and-authenticate module 86 and the network manager 80 have access to joined user and permission data 88. The join-and-authenticate module 86 acts as access-control software and/or hardware, which facilitates controlling user access to network services based on permission status.

For illustrative purposes, the application server 64 is shown further including network games 90. The local file server 70 is shown including a network hard drive 92 that stores electronic books 94, movies and videos 96, shared-file storage space 98, and music 100, which correspond to network services. The AP 16 further communicates with an Internet Service Provider (ISP) 102, which has access to the Internet 104. The web server 72 also communicates with the ISP 102 and may host websites that are accessible via the Internet 104 or via the AP 16. The printer server 74 communicates with one or more printers 44.

In operation, network users employ web-enabled client computers, such as the laptop 22 and/or the pocket computer 24, to connect to the AP 16. In the present embodiment, the access-point features system 78 monitors the AP 16 to determine when a new client is attempting to access the network 62. When a new client 22, 24 attempts to access the network 62, the join-and-authenticate module 86 queries the client 22, 24 to identify the client and the permission rights that are associated with the client 22, 24. Permission rights may be specified via one or more parameters, called permission values, that are stored in the joined-user and permission-data module 88.

The join-and-authenticate module 86 references the joined-user and permission-data module 88 as needed to authenticate the client 22, 24, i.e., to determine which permission rights are associated with the client 22, 24. The permission rights represent use rights that specify which network services that the client 22, 24 may access. In the present specific embodiment, available network services may include access to electronic books 94, movies and videos 96, shared files 98, music 100, Internet access via the ISP 102 and/or web server 72, use of the printers 44 via the printer server 74, file transfer services provided by the FTP server 66, and network games 90 running on the application server 64.

When the join-and-authenticate module 86 determines which services that each client 22, 24 is subscribed to, the advertising service 84 then triggers a display of available network services. The available network services are displayed via a user interface of the client 22, 24. The displayed network services are customized to show which services that the client 22, 24 is currently subscribed to and which services are available. For example, a list identifying network services, including access to books, music, shared files, movies and videos, Internet access, network games, and so on, may be displayed via the display of the pocket computer 24. Adjacent to each listing, an icon may indicate whether the user has permission to use each service. An additional icon or button may enable the user to purchase rights to use the associated network service in response to selecting the button. In this case, additional software and/or hardware (see service-fee-charging module 18 of FIG. 1) may be employed to charge the user based on the service selected.

Alternatively, the user may be assigned a predetermined permission level, wherein a given permission level is associated with access rights to a given set of network services. The predetermined permission level may be associated with a password that is purchased by the user from a merchant or proprietor of the network 62. The password is then provided to the join-and-authenticate module 86 by the user via the client 22, 24 and AP 16 in response to a query from the join-and-authenticate module 86.

Upon authentication or connection to the network 62, the advertising service 84 may trigger a display of all available network services without indicating which services that the client 22, 24 is subscribed to, i.e., is permitted to access and use, without departing from the scope of the present invention. Furthermore, the advertising service 84 may publish only names of services that the client 22, 24 is subscribed to, without departing from the scope of the present invention. Exact details of how available network service information is displayed and conveyed to a client 22, 24 are application specific and may readily adjusted by those skilled in the art to meet the needs of a given application without undue experimentation.

The network manager 80 running on the access-point feature system 78 enables network service personnel to determine and manage the status of all users 22, 24 of the network 62, including log-on status. For example, network personnel may employ the manager interface 82 to limit numbers of network users at any given time to facilitate controlling network resource usage. To permit or deny access to a particular service for a particular client 22, 24, the network manager 80 may issue a command to the associated server and/or module specifying that the particular client 22, 24 will or will not have access to the particular service. A client identification number, such as an IP address, may be incorporated in the command. Then, when a particular service module detects a client with a particular IP address, service access will be approved or denied accordingly. Other mechanisms may be employed to permit or deny clients 22, 24 access to network services without departing from the scope of the present invention.

Network service personnel may employ the manager interface 82 to query the join-and-authenticate module 86 and/or each server 64-74 and/or accompanying modules to determine which users are currently logged on to the network 62 and to determine which services each user is currently authorized to use. The servers 64-74 and/or accompanying modules may respond by returning information indicating which users and/or accompanying client computers 22, 24 are currently using particular services and which users are logged on to the network 62. Network personnel may then adjust such permission values and log-on status as desired. Furthermore, network service personnel may employ the manager interface 82 and network manager 80 to manually update the advertising service 84 with newly added service information. Alternatively, the network manager 80 automatically monitors available services, registering when services are removed or added to the network 62, while the access-point features system 78 and accompanying network 62 are running. The advertising service 84 may then update any listing of available network features or services to specify the newly added services.

Upon connecting to the network 62, the client systems 22, 24 may run software to automatically search for the access-point features system 78 to determine available network services, which may exist on or may be associated with one or more servers or computers. Each listed service may be organized or grouped according to functionality. For example, various printer services, movie services, library services, and so on may include sub-services that are grouped together.

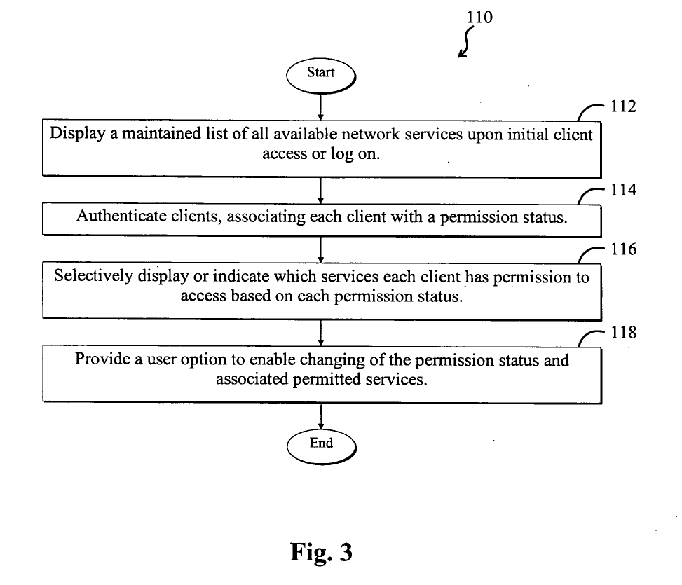

FIG. 3 is a flow diagram of a first method 110 adapted for use with the systems 10, 60 of FIGS. 1-2. With reference to FIGS. 2 and 3, in an initial displaying step 112, a list of available network services is maintained by the advertising service 84 and displayed via the client systems 22, 24 during or upon initial client access or logon to the network 62.

Subsequently, in an identification step 114, the join-and-authenticate module 86 facilitates identifying the client 22, 24 and associating the client 22, 24 with a permission status. The permission status determines which network services the client 22, 24 will be permitted to use or access.

In a subsequent displaying step 116, the advertising service 84 serves an updated list to the client computer system 22, 24 indicating which services the client 22, 24 is permitted to access based on the permission status. The updated list represents a listing of permitted services, also called subscribed services.

Subsequently, the advertising service 84 provides the user of the client system 22, 24 an option to change permission status, thereby changing the permitted services. The option may be implemented in part via a GUI displayed via user interfaces of the client computers 22, 24.

Certain steps of the method 110 may be deleted; additional steps may be added; or the order of the steps may be changed, without departing from the scope of the present invention. For example, the initial step 112 may be omitted or selectively activated in response to user input, in which case, the step 112 could appear after the step 114.

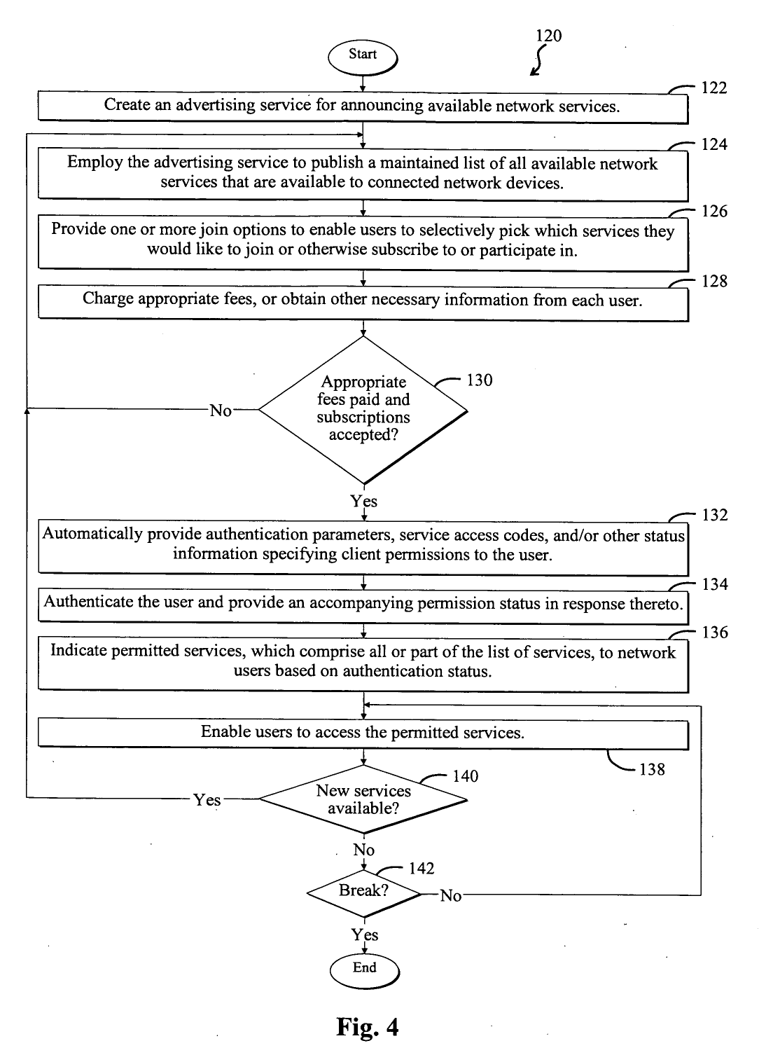

FIG. 4 is a flow diagram of a second method 120 adapted for use with the systems 10, 60 of FIGS. 1-2. With reference to FIGS. 2 and 4, in an initial advertising-service step 122, the advertising service 84 is developed and adapted to announce available network services.

In a subsequent publishing step 124, the advertising service 84 publishes a maintained list of all available network services, such as access to games 90, books 94, movies and videos 96, and so on. Each of the services may be associated with constituent sub-services for which access rights may be specified and selectively controlled. For example, book services 94 may include access to all fiction books, which might be separate from access to all nonfiction books. Use rights to sub-services may be purchased separately in certain implementations.

Subsequently, the users of the client devices 22, 24 are provided with one or more join options via the join-and-authentication module 86. The join options enable users to pick which services they would like to join or otherwise subscribe to or participate in. Such options may be implemented in part via a GUI displayed via the client systems 22, 24.

Any fees for the joined services, i.e., the subscribed services, are then charged in a charging step 128. The charging step 128 may be implemented manually by a merchant or proprietor of the network 62 without departing from the scope of the present invention. In such this case, a merchant may provide the user with an appropriate password upon payment for use rights for certain network services.

If appropriate fees have been paid as determined via a fee-checking step 130, then a permitting step 132 is performed next. Otherwise, the method 110 returns to the publishing step 124. The permitting step 132 involves automatically providing, to the clients 22, 24, authentication or identification parameters, service access codes, and/or other status information specifying client permissions. The clients 22, 24 are then authenticated in an authentication step 134 based on the identification parameters.

Subsequently, an indicating step 136 is performed. The indicating step 136 involves forwarding, to the clients 22, 24, information specifying subscribed services, which comprise all or part of the list of available network services, based on the authentication status of each client 22, 24. The information may then be displayed via the user interfaces of the clients 22, 24.

Subsequently, in an accessing step 138, users are granted access to permitted services and not granted access to other services. The clients 22, 24 may continue using the services. If new services are available as determined in a service-checking step 140, a parallel process may be spawned, beginning at the publishing step 124, which enables the users to be notified of newly available services while the users employ the subscribed services.

If a system break is detected in a break-checking step 142, the method 110 ends. Otherwise, the clients 22, 24 may continue accessing permitted services as represented by step 138.

Various steps of the method 120 may be omitted, re-ordered, or omitted without departing from the scope of the present invention.

Hence, with reference to FIGS. 1-4, the systems 10, 60 and methods 110, 120 provide a standardized way to list and share network services, such as WLAN services. Various embodiments of the present invention may be readily adapted to work with existing WLANs and PWLANs by those skilled in the art with access to the present teachings without undue experimentation.

The methodology disclosed herein may allow wireless access points, wireless domain services, or other types of networks to list features and tools as services to facilitate access and use of the features and tools. Such listing is particularly beneficial for controlling access in a guest-access or PWLAN environment. Such methodologies enable customers to log on to associated wireless networks; to list services available in the associated wireless domain; and to use the services.

Embodiments of the present invention may be employed to simplify listing and sharing of network services for various types of networks, not just wireless networks. In summary, the simplification may be readily performed by maintaining a list of all available services; creating an advertising service to announce available services; providing a join feature, enabling queries to a server, such as a Remote Authentication Dial-In User Service (RADIUS) or other authentication server or module (see module 86 of FIG. 2), to facilitate determining logged-in users/computers and to manage permission rights to network services; and refreshing the service list as needed to facilitate dynamic services, such as interactive gaming, and to update clients with newly announced services.

Various embodiments of the present invention may not only simplify sharing information about services in a given network, but may further facilitate automatically configuring known services to enable different users to access the services even while the services are running. Those skilled in the art with access to the present teachings may readily implement such functionality in hardware and/or software without undue experimentation. Such embodiments may enable merchants to receive additional revenue by selling network-service use rights to customers.

While the present embodiment is discussed with reference to systems and methods for facilitating access to network services in WLANs, embodiments of the present invention are not limited thereto. For example, many types of networks, either wired or wireless may benefit from service listing and access functionality afforded by embodiments of the present invention.

Although embodiments of the invention are discussed primarily with respect to server-client architecture, any acceptable architecture, topology, protocols, or other network and digital processing features can be employed. In general, network controllers, managers, access points, clients, and so on, can be implemented via any device with processing ability or other requisite functionality.

Although processes of the present invention and the hardware executing the processes may be characterized by language common to a discussion of the Internet (e.g., “client,” “server,” “peer”), it should be apparent that operations of the present invention can execute on any type of suitable hardware in any communication relationship to another device on any type of link or network.

Although a process of the present invention may be presented as a single entity, such as software executing on a single machine, such software can readily be executed on multiple machines. That is, there may be multiple instances of a given software program, a single program may be executing on two or more processors in a distributed processing environment, parts of a single program may be executing on different physical machines, etc. Furthermore, two different programs, such as a client and server program, can be executing in a single machine, or in different machines. A single program can be operating as a client for one information transaction and as a server for a different information transaction.

Any type of processing device can be used as a client. For example, portable computing devices such as a personal digital assistant (PDA), cell phone, laptop computer, or other devices can be employed. In general, the devices and manner of specific processing (including location and timing) are not critical to practicing important features of the present invention.

Although the invention has been discussed with respect to specific embodiments thereof, these embodiments are merely illustrative, and not restrictive, of the invention. Embodiments of the present invention can operate between any two processes or entities including users, devices, functional systems, or combinations of hardware and software. Peer-to-peer networks and any other networks or systems where the roles of client and server are switched, change dynamically, or are not even present are within the scope of the invention.

Any suitable programming language can be used to implement the routines or other instructions employed by various network entities. Exemplary programming languages include C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “machine-readable medium” or “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented in whole or in part by using a programmed general purpose digital computer; by using application specific integrated circuits, programmable logic devices, field programmable gate arrays, optical, chemical, biological, quantum or nanoengineered systems or mechanisms; and so on. In general, the functions of the present invention can be achieved by any means as is known in the art. Distributed or networked systems, components, and/or circuits can be used. Communication, or transfer of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow “a”, “an”, and “the” include plural references unless the context clearly dictates otherwise. Furthermore, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A method for facilitating access to services in a network comprising:
maintaining a list of network features;
accepting user connections to the network; and
automatically displaying the list or portion thereof upon accepting a user connection.

2. The method of claim 1 wherein the step of accepting further includes
authenticating a user and selectively associating one or more permission values with the user or with a network device employed by the user.

3. The method of claim 2 further including
providing a user option to enable changing of the one or more permission values.

4. The method of claim 2 wherein the step of automatically displaying further includes
indicating which of the list of network features may be utilized by the user or the network device based on the one or more permission values.

5. The method of claim 4 further including
associating one or more services with each network feature of the list of network features, each of the network features employing one or more network elements.

6. The method of claim 5 further including
selectively communicating the one or more permission values to the one or more network elements to thereby disable or enable network services associated therewith based on the one or more permission values.

7. The method of claim 5 further including
enabling network personnel to query a network device to facilitate determining information pertaining to users and/or computers that are logged on to the network.

8. The method of claim 7 further including
enabling the network personnel to at least partially control permission and/or access rights to each of the services.

9. The method of claim 5 further including
selectively updating the list of features to incorporate newly offered features.

10. A method for facilitating access to services in a network comprising:
maintaining information pertaining to available network services;
selectively announcing the available network services;
providing one or more join options to enable a network user to influence which of the network services that the user will have permission to use or access and providing client permission information in response thereto; and
employing the client permission information to selectively indicate to the user which of the available network services may be used or accessed by the user.

11. The method of claim 10 further including
enabling the user to use or access available network services for which the user has permission to use or access as indicated by the permission information.

12. The method of claim 10 further including
detecting when new network services become available and returning to the step of providing in response thereto.

13. The method of claim 10 wherein the step of providing further includes
charging fees based on which of the network services that the user will have permission to use or access.

14. An apparatus for facilitating use of services in a network comprising:
one or more network connections between one or more user devices and said network;
an authentication system that authenticates a user of the one or more user devices and provides a signal in response thereto; and
one or more service-listing modules adapted to selectively display information pertaining to services of the network in response to the signal.

15. The apparatus of claim 14 wherein the network includes
a wireless network.

16. The apparatus of claim 15 wherein the network includes
a Public Wireless Local Area Network (PWLAN).

17. The apparatus of claim 16 wherein the one or more network connections are implemented via
one or more local access points in communication with the one or more user devices.

18. The apparatus of claim 17 wherein the one or more local access points are constructed according to IEEE (Institute of Electrical and Electronics Engineers) 802.11 standards.

19. The apparatus of claim 14 wherein the authentication system includes
one or more authentication routines adapted to determine which of the services that the user is permitted to access and to provide permission information in response thereto, the permission information being incorporated in the signal.

20. The apparatus of claim 19 wherein the one or service-listing modules implement
one or more service-listing routines that employ the permission information to indicate via a display, which of the services that the user is authorized to use or access.

21. The apparatus of claim 19 wherein the authentication system further includes
one or more additional modules that enable the user to alter the permission information, thereby enabling the user to adjust which of the services that the user may use or access.

22. The apparatus of claim 21 wherein the one or more additional modules include
user-interface software and/or hardware accessible by the user via a user device.

23. The apparatus of claim 22 further including
a server that runs the user-interface software and/or hardware.

24. The apparatus of claim 21 further including
a fee-charging module that facilitates charging the user a fee according to which of the services the user has chosen to use or access as indicated via the permission status.

25. The apparatus of claim 19 wherein the permission information specifies one or more service-access levels, each of the service-access levels associated with a particular set of network services.

26. The apparatus of claim 25 wherein the services are grouped according to functionality.

27. The apparatus of claim 14 wherein the one or more service-listing modules include
a display in communication with one or more routines adapted to automatically display all network services offered by the network upon client logon to the network and to further display an indication to the user specifying which of the network services are accessible to the user based on the signal.

28. The apparatus of claim 14 further including
a manager interface that enables one or more authorized network users to manage permission and/or access rights to each of the network services.

29. The apparatus of claim 28 wherein the manager interface includes
network-manager hardware and/or software adapted to enable monitoring of users and/or computers that are logged-in to the network.

30. The apparatus of claim 28 wherein the apparatus further includes
one or more access-control modules that facilitate controlling use of the network services based on the signal.

31. The apparatus of claim 30 wherein the services are implemented via one or more network devices.

32. The apparatus of claim 31 wherein the one or more access-control modules include
access-control software and/or hardware running on the network, the access-control software and/or hardware in communication with each of the one or more network devices providing the services.

33. A system for facilitating use of services in a network comprising:
first means for enabling a user to connect to the network;
second means for authenticating the user and providing a signal in response thereto; and
third means for selectively displaying information pertaining to services of the network in response to the signal.

34. An apparatus for facilitating use of services in a network, wherein a user device is coupled to the network, the apparatus comprising:
one or more processors;
a machine-readable medium including instructions executable by the one or more processors for
maintaining a list of network features;
accepting user connections to the network; and
automatically displaying the list or portion thereof upon accepting a user connection.

35. A computer-readable medium including instructions for facilitating use of services in a network, wherein a user device is coupled to the network, the computer-readable medium comprising:
one or more instructions for maintaining a list of network features;
one or more instructions for accepting user connections to the network; and
one or more instructions for automatically displaying the list or portion thereof upon accepting a user connection.
